(19) United States
(12) Patent Application Publication
(10) Pub. No.: US 2026/0297259 A1
(43) Pub. Date: Oct. 1, 2026

(54) AN INTERMEDIATE COMPOSITION

(71) Applicant: Kemira Oyj, Helsinki (FI)

(72) Inventors: Asko KARPPI, Espoo (FI); Taru JOKINEN, Espoo (FI)

(21) Appl. No.: 19/480,888

(22) PCT Filed: May 2, 2024
(86) PCT No.: PCT/FI2024/050211

§ 371 Date: Nov. 3, 2025

(30) Foreign Application Priority Data
May 3, 2023 (FI) 20235490

(51) Int. Cl. C08G 73/02; C08K 3/16; C08K 3/28; C08K 3/30; C08K 3/32

(52) U.S. Cl. CPC C08G 73/0286; C08K 3/16; C08K 3/28; C08K 3/30; C08K 3/32; C08K 2003/309; C08K 2003/329

(57) ABSTRACT

The invention relates to an intermediate composition in form of an aqueous solution, having a dry solids content of 30-65 weight-%, for manufacture of a polyamidoamine epihalohydrin resin. The intermediate composition comprises a regulating acid, and 30-60 weight-%, calculated from the total weight of the intermediate composition, of a polyamidoamine derivative having covalently bound epihalohydrin groups and covalently bound azetidinium groups, wherein the intermediate composition comprises derivative bound halogen in an amount of ≤90 g/kg, calculated from the dry solids.

The present invention relates to an intermediate composition in form of an aqueous solution suitable for manufacture of polyamidoamine epihalohydrin resins according to the preamble of the enclosed independent claim.

Polyamidoamine epihalohydrin (PAE) resins are used in manufacture of fibrous webs, such as paper, board, tissue and the like, in order to improve the wet strength of the produced webs. Conventionally, PAE resins are produced in a multistage process from a dibasic carboxylic acid, a polyamine and epihalohydrin, to form a polyamidoamine derivative comprising pendant halohydrin groups. In the final stages of the PAE resin production, the pendant halohydrin groups of the polyamidoamine derivative are transformed into azetidinium groups, and the PAE resin is crosslinked through these groups to the desired molecular weight.

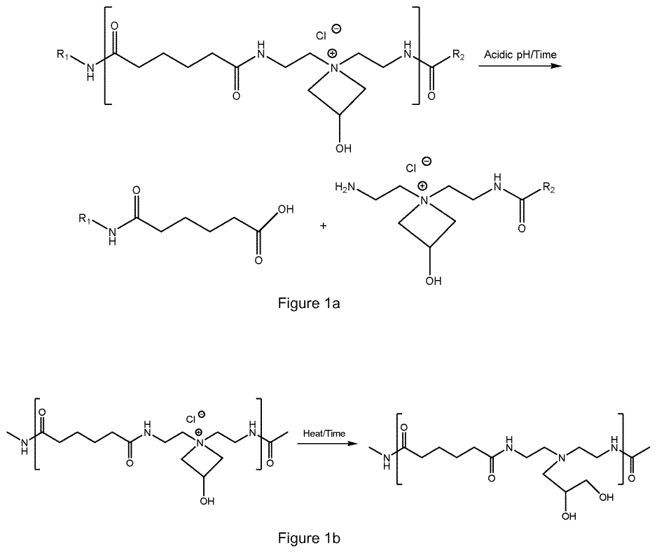

The stability of PAE resin is an important aspect in its manufacture and use. In ideal case, the PAE resin should be both physically and chemically stable, and maintain its physical properties, such as viscosity, and chemical properties, such as charge density, during the time between its manufacture and use, including possible transport and storage. Unfortunately, the conventional PAE resins have a limited temporal stability, as the crosslinking reaction in the resin continues after its initial formation, which leads to undesired increase in molecular weight and viscosity of the PAE resin with time. If the molecular weight of the PAE resin, and thus its viscosity, increases too much, the resin becomes unworkable, and may even cause disturbances or interruptions in manufacture of fibrous web. The viscosity increase of the PAE resin caused by crosslinking through azetidinium groups can be reduced by adjusting the pH of the resin to an acidic level around pH 2.5-3.5. However, during storage acidic pH may cause hydrolysis of the resin backbone, as illustrated in FIG. 1a. The hydrolysis of the backbone is further increased in temperatures exceeding 30° C. It is seen from FIG. 1a that the hydrolysis of the resin backbone leads to shortening of the chain length and formation of polyamide. The hydrolysis of the resin backbone is disadvantageous as it negatively affects the wet strength effect obtainable with the PAE resin when used in manufacture of fibrous webs.

In general, the chemical stability of polyamidoamine epihalohydrin resins is influenced by the temperature. PAE resins are relatively stable at temperatures of 25° C. and below, but they become unstable at higher temperatures, where the resins may lose cationic charges through hydrolysis of azetidinium groups. One possible reaction scheme for azetidinium hydrolysis is shown in FIG. 1b. The exact reaction, and the resulting reaction product may vary, but it has been observed that during storage the pH of the resin increases. Reduced chemical stability is also observed as a significant decrease in the charge density of the resin. The charge density of a PAE resin may even decrease up to 50% during one month of storage. This phenomenon occurs already at temperatures around 35° C., which are quite typical during summertime storage and may become even more common in future due to the climate change. PAE resins are also subjected to elevated temperatures on application sites, where they are stored for prolonged times, for example due to process delays or unplanned production stops at paper and board mills. The decreased charge density deteriorates the wet strength performance of the PAE resin.

In order to minimise the problems caused by increasing viscosity, the PAE resins are often stored and transported as solutions with low resin concentration. This counteracts the effects of the viscosity increase, but at the same time increases the transport costs of the resin and may complicate its manufacture and/or use. Another alternative is to produce a prepolymer of polyamine and dibasic acid, which is then reacted with epihalohydrin on the application site, thus minimising the time frame between the resin production and use. However, handling of epihalohydrin is complicated, requires special knowledge as well as special chemical permits. There have also been suggestions to provide intermediate compositions comprising polyamidoamine derivatives of a dibasic carboxylic acid, a polyamine and epihalohydrin, which could be “activated” on-site by change of pH or temperature increase. However, there is still need for improvements in stability of intermediate compositions intended for PAE resin manufacture, as they suffer similar issues relating to physical and chemical instability, as explained above.

An object of this invention is to minimise or possibly even eliminate the disadvantages existing in the prior art.

An object of this invention is also to provide an intermediate composition for production of polyamidoamine halohydrin resins, which shows good stability and reactivity, even after a storage at an elevated temperature.

A further object of this invention is also to provide an intermediate composition, which is especially suitable for on-site manufacture of polyamidoamine halohydrin resins.

These objects are attained with the invention having the characteristics presented below in the characterising parts of the independent claims. Some preferable embodiments are disclosed in the dependent claims.

The features recited in the dependent claims and the embodiments in the description are mutually freely combinable unless otherwise explicitly stated.

The exemplary embodiments presented in this text and their advantages relate by applicable parts to all aspects of the invention, even though this is not always separately mentioned.

The typical intermediate composition according to the present invention, is in form of an aqueous solution, having a dry solids content of 30-65 weight-%, preferably 40-65 weight-%, and stabilized by a regulating acid, for manufacture of a polyamidoamine epihalohydrin resin, the intermediate composition comprising 30-60 weight-%, preferably 35-60 weight-%, calculated from the total weight of the intermediate composition, of a polyamidoamine derivative having covalently bound epihalohydrin groups and covalently bound azetidinium groups, wherein the intermediate composition comprises derivative bound halogen in an amount of ≤90 g/kg, calculated from the dry solids.

Now it has been surprisingly found that when the polyamidoamine derivative comprises a specific amount of polyamidoamine derivative bound halogen, as defined in present invention, the chemical reactions occurring in the intermediate composition during the storage, even and especially at elevated temperatures, counterbalance each other. The conversion of acid stabilized halohydrin groups into azetidinium groups decreases the pH of the composition, while simultaneously occurring hydrolysis of azetidinium groups increases the pH of the composition. It was unexpectedly realised that when the intermediate composition comprises polyamidoamine derivative with the carefully specified amount of acid stabilized halohydrin groups, reflected by the amount of derivative bound halogen, the parallelly occurring chemical reactions proceed both at their own reaction speeds and balance each other. This means that the pH of the intermediate composition is stabilised to a level, providing both physical and chemical stability for the polyamidoamine derivative and for the intermediate composition. The viscosity of the intermediate composition can be maintained on the desired level and the risk for hydrolysis of polyamidoamine derivative backbone is decreased. No significant change in the charge density of the intermediate composition occurs, either. The reactions in the intermediate composition thus act as a “buffer”, and provide conditions which at the same time reduce the progress of the reactions to an acceptable level. The intermediate composition of the present invention can be seen as “self-regulating”, in terms of both chemical and physical stability.

In the present context, the term “derivative bound halogen” describes the (amount of) halogen ions that are covalently bound to the polyamidoamine derivative structure. The derivative bound halogen indicates the amount of halohydrin groups in the polyamidoamide derivative. The derivative bound halogen can be determined by
1) determining the total amount of adsorbable organic halogen AOX, by using standard ISO 9562:2004, as described in the experimental part;
2) determining the total amount of residual epihalohydrin and the halogen containing by-products, especially 1,3-dihalo-2-propanol (DCP) and 3-halopropyleneglycol (CPD), in the intermediate composition by using gas chromatography (known per se to a person skilled in the art) and calculating the amount of halogen bound to residual epihalohydrin and by-products (here conjointly denoted as by-product bound halogen) on basis of the determination; and then
3) calculating the derivative bound halogen by subtracting from the total amount of AOX the amount of by-product bound halogen.

Preferably the derivative bound halogen indicates derivative bound chloride.

The amount of derivative bound halogen, preferably chloride, in the intermediate composition is ≤90 g/kg, preferably ≤80 g/kg, calculated from the total dry solids of the intermediate composition. According to one embodiment, the intermediate composition comprises derivative bound halogen ≥30 g/kg, preferably ≥35 g/kg, more preferably ≥40 g/kg, even more preferably ≥45 g/kg or ≥50 g/kg, sometimes even ≥55 g/kg. For example, according to one preferable embodiment, the intermediate composition may comprise derivative bound halogen in the amount of 20-90 g/kg or 30-90 g/kg, preferably 35-85 g/kg, more preferably 40-80 g/kg or 45-80 g/kg, even more preferably 50-80 g/kg, sometimes 55-80 g/kg, calculated from the total dry solids of the intermediate composition. When the amount of derivative bound halogen in the intermediate composition is within these limits, the pH of the intermediate composition is effectively stabilised, so that the pH change, even at the elevated temperature of ≥30° C., is less than 4 pH units, preferably less than 3 pH units, more preferably less than 2.5 or 2 pH units. The amount of derivative bound halogen may slowly decrease as a function of time, as the various reactions within the intermediate composition proceed, each at their own speed. However, the chemical and physical properties of the intermediate composition, such as the pH, viscosity and the charge density, are maintained at appropriate levels due to the self-regulating nature of the intermediate composition of the present invention.

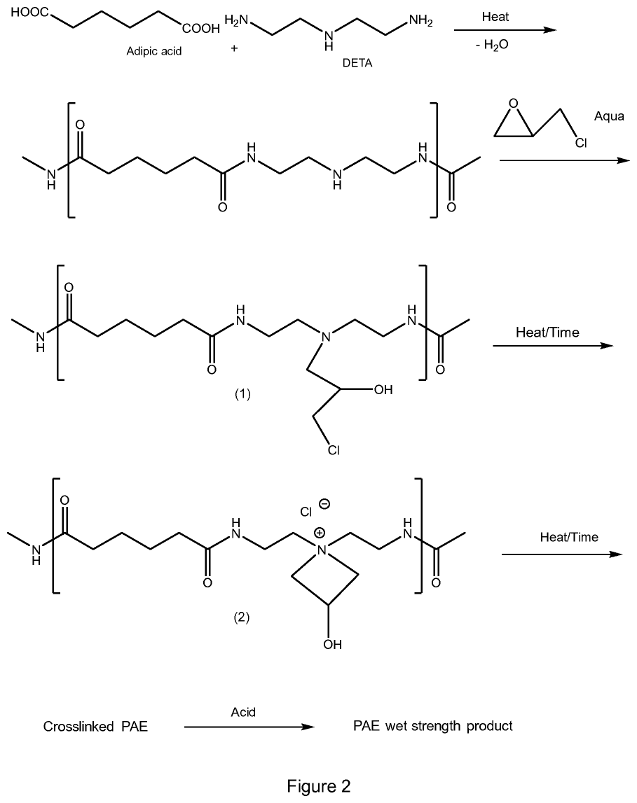

In the present context, polyamidoamine derivative is understood as a polymer obtained by a reaction between polyamidoamine and epihalohydrin, preferably epichlorohydrin. The polyamidoamine derivative is thus polyamidoamine epihalohydrin compound with pendant groups originating from epihalohydrin, i.e. pendant halohydrin groups, as well as pendant azetidinium groups. The pendant halohydrin groups are preferably tertiary aminohalohydrin groups. The backbone of the polyamidoamine derivative is polyamidoamine, obtained by a condensation reaction of a dibasic carboxylic acid and a polyamine, such as a polyalkylenepolyamine. The condensation reaction is shown in FIG. 2. FIG. 2 demonstrates the reaction by using preferable options for dibasic carboxylic acid and polyamine, i.e. adipic acid and diethylenetriamine, but other dibasic carboxylic acids and polyamines may be used as well. The condensation reaction between the dibasic carboxylic acid and the polyamine may be performed at a temperature in a range from 120-180° C., preferably 140-180° C., more preferably 150-170° C., at atmospheric pressure. The condensation reaction produces water as by-product, which may be removed by distillation.

The dibasic carboxylic acid for producing the polyamidoamine may be selected from a group comprising adipic acid, glutaric acid, oxalic acid, malonic acid, succinic acid, itaconic acid, azelaic acid, as well as their derivatives such as esters, half-esters, acid halides and anhydrides, and any of their mixtures. For example, a suitable derivative of dibasic carboxylic acid may be dimethyl glutarate, diethyl glutarate, dimethyl adipate, diethyl adipate, dimethyl succinate and/or diethyl succinate. Adipic acid is a preferable dibasic carboxylic acid. The polyamine for producing polyamidoamine may be selected from a group comprising polyalkylenepolyamines, such as polyethylenepolyamine, polypropylenepolyamine, polybutylenepolyamine, polypentylenepolyamine, polyhexylenepolyamine and any of their mixtures, in particular diethylenetriamine, triethylenetetramine, tetraethylenepentamine, dipropylenetriamine, tripropylenetetramine, pentaethylenehexamine, aminoethyl-piperazine and any of their mixtures, bis(3-aminopropyl)amine, methylbis(3-aminopropyl)amine, ethylbis(3-aminopropyl)amine, N-(3-aminopropyl)tetra-methylenediamine, N,N′-bis(3-aminopropyl)tetramethylenediamine, N,N-bis(2-aminoethyl)-ethylenediamine, diaminoethyl triaminoethylamine and piperazmethyl triethylenetetramine. Diethylenetriamine is a preferable polyamine.

The molar ratio of dicarboxylic acid and polyamine, preferably polyalkylene-polyamine, such as diethylenetriamine, for forming the polyamidoamine may be from 1:0.95 to 1:1.1, preferably from 1:1 to 1:1.1, typically around 1:1.

The ratio of polyamidoamine prepolymer and epihalohydrin for producing the polyamidoamine derivative, may be from 66:34 to 70:30, given in weight-%.

The reaction between polyamidoamine and epihalohydrin results in polyamidoamine derivative according to formula (1) of FIG. 2. The polyamidoamine derivative, obtained after the reaction of the polyamidoamine and epihalohydrin, has covalently bound pendant halohydrin groups, and pendant azetidinium groups, connected to the polyamidoamine derivative backbone. An example of this is shown in FIG. 2, where the polyamidoamine derivative of formula (1) contains a pendant chlorohydrin group. Pendant azetidinium groups are not shown in formula (1) of FIG. 2, but it is understood that in the intermediate composition the polyamidoamine derivatives comprise also pendant azetidinium groups, in addition to pendant halohydrin groups. In the polyamidoamine derivative backbone, formed from the dicarboxylic acid and polyamine units, the pendant groups are preferably bound to the secondary amines of the polyamine units.

According to the present invention the polyamidoamine derivative may comprise 30-80 mol-% of pendant halohydrin groups, calculated from molar amount of polyamine units present in polyamidoamine derivative. The amount of pendant halohydrin groups can be determined by using 13C NMR method, for example as described in EP 1627006. According to one preferable embodiment, the polyamidoamine derivative may comprise 50-80 mol-% or 60-80 mol-%, preferably 60-77 mol-%, more preferably 65-77 mol-% of pendant halohydrin groups, calculated from molar amount of polyamine units present in polyamidoamine derivative. According to one embodiment, the polyamidoamine derivative may comprise 55-75 mol-%, preferably 55-74 mol-%, more preferably 60-70 mol-% of pendant halohydrin groups, calculated from molar amount of polyamine units present in polyamidoamine derivative. This means that a large number, even a majority, of the pendant groups in the polyamidoamine derivative are in form of halohydrin groups, as also indicated by the amount of derivative bound halogen, preferably in form of chlorohydrin groups. When the amount of pendant groups in the polyamidoamine derivative is adjusted to the suggested level, the stability of the intermediate composition is improved, especially during transport and storage involving elevated temperature of 30° C. or more. At elevated temperatures, e.g. around 30-40° C., the halohydrin groups of the intermediate composition are slowly converted into azetidinium groups, which means that the pH of the intermediate composition is decreased. The decreased pH simultaneously prevents gelling of the intermediate composition. This provides the intermediate composition with appropriate temperature resistance as well as charge stability. According to one embodiment polyamidoamine derivative in the composition may comprise 65-79 mol-% of pendant halohydrin groups, calculated from molar amount of polyamine units present in polyamidoamine derivative.

According to one embodiment of the present invention a ratio of derivative bound halogen ions to non-bound halogen ions in the intermediate composition is ≤5. The non-bound halogen ions originate from the transformation of halohydrin groups to azetidinium groups, and thus describe the progress of transformation reaction. The non-bound halogen ions can be determined from the intermediate composition by a potentiometric titration by using a suitable titrant, known as such for a person skilled in the art. Potentiometric titration of chloride is exemplified in the experimental part. The ratio of derivative bound halogen ions to non-bound halogen ions is a good parameter for finding the area where the intermediate composition shows good stability when the regulating acid is different from hydrochloric acid. For example, when the regulating acid is sulphuric acid, the intermediate composition shows good physical and chemical stability when the ratio of derivative bound halogen to non-bound halogen ions in the intermediate composition is ≤5. According to one preferable embodiment the ratio is 0.5-5, preferably 1-4.5, more preferably 1.5-4.0.

The polyamidoamine derivative of the intermediate composition comprises pendant azetidinium groups. According to one preferable embodiment polyamidoamine derivative may comprise 20-40 mol-%, preferably 21-40 mol-% or 23-40 mol-%, more preferably 21-35 mol-% or 25-35 mol-%, of pendant azetidinium groups, calculated from molar amount of polyamine units present in polyamidoamine derivative. The polyamidoamine derivative may comprise 25-45 mol-%, preferably 26-45 mol-%, more preferably 30-40 mol-%, of pendant azetidinium groups, calculated from molar amount of polyamine units present in polyamidoamine derivative. When the amount of azetidinium groups is within these ranges, the hydrolysis reaction of the azetidinium reaction, is able to balance out the other reactions influencing the pH of the composition. According to one preferable embodiment polyamidoamine derivative in the composition may comprise 21-35 mol-% of pendant azetidinium groups, calculated from molar amount of polyamine units present in polyamidoamine derivative. This differs from the conventional polyamidoamine intermediates, where typically as high proportion of pendant azetidinium groups as possible is desired.

The intermediate composition of the present invention is in form of an aqueous solution and it comprises a regulating acid. This means that in addition to the polyamidoamine derivative, the intermediate composition comprises or consists of water and the regulating acid. According to one preferable embodiment, the intermediate composition consists of polyamidoamine derivative, regulating acid and water. The regulating acid is preferably added to the intermediate composition to provide the desired pH for the composition, as defined elsewhere in this application. The dry solids content of the intermediate composition may be 20-65 weight-%. The dry solids content of the intermediate composition is typically 30-65 weight-% or 31-65 weight-%, preferably 35-65 weight-%, more preferably 40-65 weight-%. The dry solids of the intermediate composition typically consist of polyamidoamine derivative and the regulating acid. The dry solid content of the intermediate composition makes it suitable for transport and storage, minimising the amount of water to be transported, while maintaining the handling properties of the composition, e.g. pumpability. According to one embodiment the intermediate composition has the dry solids content in the range of 45-65 weight-%, preferably 50-60 weight-%, more preferably 50-58 weight-%.

The pH of the intermediate composition may be carefully adjusted for providing the optimal conditions for reactions which stabilize the intermediate composition. The acidic pH of the intermediate composition provides desired stability, prevents the premature crosslinking of the polyamidoamine derivative and makes the intermediate composition suitable for transport and storage. The intermediate composition may have a pH value ≤4, preferably ≤3.7, more preferably ≤3.5. Preferably, the pH value of the intermediate composition may be ≥2.8, more preferably ≥3.0, even more preferably ≥3.1. According to one embodiment of the present invention the intermediate composition may have the pH value in a range of 2.8-4, preferably 3.0-3.8, more preferably 3.1-3.8, even more preferably 3.2-3.7, 3.2-3.6 or 3.2-3.5. In one embodiment, the intermediate composition may have the pH value in the range of 3.3-3.7. The pH of the intermediate composition may be adjusted by use of a regulating acid, which is added to intermediate composition. Any acid, organic acid or inorganic acid, or their mixture may be used. Suitable organic acid may be, for example formic acid, acetic acid or methanesulphonic acid. Preferably the regulating acid is an inorganic acid. The inorganic acid may be selected from a group comprising hydrochloric acid, sulphuric acid, nitric acid, phosphoric acid, or any of their combinations. Preferably the regulating acid is sulphuric acid.

The intermediate composition may comprise 1-20 weight-%, preferably 3-15 weight-%, more preferably 5-13 weight-% of regulating acid, as dry, calculated from the total weight of the intermediate composition.

The intermediate composition may comprise 30-64 weight-% or 35-60 weight-%, of a polyamidoamine derivative with covalently bound epihalohydrin groups and covalently bound azetidinium groups, calculated from the total weight of the intermediate composition. According to one preferable embodiment, the intermediate composition may comprise 31-60 weight-%, preferably 35-60 weight-% or 40-60 weight-%, of a polyamidoamine derivative with covalently bound epihalohydrin groups and covalently bound azetidinium groups, calculated the total weight of the intermediate composition. The content polyamidoamine derivative in the intermediate composition is preferably as high as possible, which makes the transport of the intermediate composition more cost effective. The polyamidoamine derivative content of the intermediate composition provides, together with pH, and halohydrin group content, the appropriate conditions, which support the chemical reactions maintaining both physical and chemical stability of the intermediate composition. According to one preferable embodiment, the intermediate composition comprises 35-58 weight-%, preferably 43-57 weight-%, more preferably 43-55 weight-% or 45-55 weight-%, calculated from the total weight of the composition, of the polyamidoamine derivative, given as dry. In practice the main components of the intermediate composition are polyamidoamine derivative and water, which two components make up at least 80 weight-% or at least 85 weight-%, preferably at least 90 weight-%, more preferably at least 95 weight-%, of the total weight of the intermediate composition. For example, the intermediate composition may comprise 80-99 weight-%, preferably 85-97 weight-%, more preferably 87-95 weight-%, of the polyamidoamine derivative and water, calculated from the total weight of the composition. The remaining, up to 100 weight-%, is typically made up of the regulating acid.

According to one embodiment of the invention the polyamidoamine derivative may have a weight average molecular weight of ≤150 000 g/mol, preferably ≤100 000 g/mol, more preferably ≤50 000 g/mol, even more preferably ≤35 000 g/mol. The weight average molecular weight of the polyamidoamine derivative may be 4000 g/mol or more, preferably 5000 g/mol or more. For example, the weight average molecular weight of the polyamidoamine derivative may be in a range of 4000-150 000 g/mol or 4000-100 000 g/mol, preferably 5000-50 000 g/mol, more preferably 5000-35 000 g/mol. The weight average molecular weights for the present purposes are measured by using SEC/GPC determination with PEO (polyethyleneoxide) calibration as described in the following. The weight average molecular weight MW is determined by size-exclusion chromatography (SEC) using Agilent 1100 SE chromatography equipment with integrated pump, autosampler and degasser. Eluent is a buffer solution (0.3125 M CH₃COOH+0.3125 M CH₃COONa) with a flow rate of 0.5 ml/min at 35° C. Typical sample concentration is 2-4 mg/ml, with an injection volume of 50 μl. Ethylene glycol (1 mg/ml) is used as a flow marker. The used column set consists of three columns (one TSKgel PWXL guard column and two TSKgel GMPWXL columns). Refractive index detector by Agilent is used for detection (T=35° C.). Molecular weight is determined using conventional column calibration with poly(ethylene oxide)/poly(ethylene glycol) narrow molecular weight distribution standards (Polymer Standards Service).

The intermediate composition may have a viscosity value in a range of 50-2000 mPas, preferably 50-1000 mPas, more preferably 100-700 mPas, even more preferably 150-500 mPas. The viscosity is measured by using Brookfield LV DV1, equipped with small sample adapter, at 25° C., using spindle S18. The highest feasible rotation speed for the spindle was used, and the viscosity is measured at the concentration and pH of the intermediate composition as is.

According to one embodiment of the invention, the intermediate composition comprises polyamidoamine derivative which is non-crosslinked.

The intermediate composition may comprise a low amount of organic and/or inorganic salts, especially halogen salts, such as chloride salts.

According to one embodiment of the invention the intermediate composition may have a non-bound halogen ion, especially chloride ion, content <5 weight-%, preferably <3.5 weight-%, more preferably <3.0 weight-%, even more preferably <2.5 weight-%, calculated from the total dry weight of the intermediate composition. For example, the intermediate composition may have a non-bound halogen ion, especially chloride ion, content in a range of 0-4.9 weight-%, preferably 0.1-3.4 weight-%, more preferably 0.1-2.9 weight-%, even more preferably 0.5-2.4 weight-%. The non-bound halogen ions are those halogen ions present in the intermediate composition, which are free from covalent bonds to the polyamidoamine derivative.

The intermediate composition may contain epihalohydrin and/or by-products or residuals originating from epihalohydrin in a total amount of less than 10000 ppm, preferably less than 8000 ppm, more preferably less than 7000 ppm, calculated from the total dry weight of the intermediate composition.

According to one embodiment of the present invention the intermediate composition can be purified by removal of non-reacted epihalohydrin and undesired by-products, such as of 1,3-dihalo-2-propanol (DCP), such as 1,3-dichloro-2-propanol, and 3-halopropyleneglycol (CPD), by using any suitable purification method or their combination. According to one embodiment of the invention the intermediate composition may be purified, e.g. by precipitation or filtration, such as membrane filtration, after the reaction of the polyamidoamine and epihalohydrin at a temperature <20° C. The intermediate composition may be purified, for example, by using nanofiltration or ultrafiltration. Nanofiltration uses membranes with pore size from 1 nm to less than 5 nm, and ultrafiltration uses membranes with pore size from 5 nm to 100 nm. It has been observed that the removal of non-reacted epihalohydrin, by-products and residuals is significantly improved, when the purification step is performed to the intermediate composition. The purification does not influence the stability of the intermediate composition. After the purification the total amount of epihalohydrin and by-products or residuals originating from epihalohydrin may be less than 2000 ppm, preferably less than 1000 ppm, more preferably less than 700 ppm, even more preferably less than 500 ppm, calculated from the total dry weight of the intermediate composition. Preferably, after purification the total amount of epihalohydrin and the by-products may be <400 ppm, preferably <300 ppm, even <200 ppm, calculated from the total dry weight of the intermediate composition. For example, the total amount of epihalohydrin and the by-products originating from epihalohydrin may be in a range of 5-400 ppm, preferably 10-300 ppm, sometimes even 20-200 ppm, calculated from the total dry weight of the intermediate composition.

According to one embodiment, the intermediate composition may comprise by-products selected from 1,3-dihalo-2-propanol (DCP), such as 1,3-dichloro-2-propanol, and 3-halopropyleneglycol (CPD), such as 3-chloropropyleneglycol, in a total amount of less than 3500 ppm, calculated from the total dry weight of the intermediate composition. According to one preferable embodiment the total amount of 1,3-dihalo-2-propanol (DCP) and 3-halopropyleneglycol (CPD) in the intermediate composition may be less than 2000 ppm, preferably less than 1000 ppm, more preferably less than 700 ppm, even more preferably less than 500 ppm, sometimes even less than 200 ppm or less than 100 ppm, calculated from the total dry weight of the intermediate composition. Preferably the total amount of 1,3-dihalo-2-propanol (DCP), such as 1,3-dichloro-2-propanol, and 3-halopropyleneglycol (CPD), such as 3-chloropropyleneglycol, is as small as possible. The total amount may be, for example, in a range of 0-3500 ppm or 0-2000 ppm, preferably 0-1000 ppm, more preferably 0-700 ppm, even more preferably 0-500 ppm, calculated from the total dry weight of the intermediate composition.

The intermediate composition according to the present invention is especially suitable for on-site or near-site production in manufacture of fibrous webs, as the polyamidoamine derivative concentration is high, enabling significant savings in transportation and/or storage costs. The intermediate composition itself is not effective as wet strength agent before final crosslinking. The final crosslinking of the polyamidoamine derivative is initiated in an on-site process by increasing the pH of the intermediate composition. For example, the intermediate composition may be prepared at a chemical factory and transported to a site of use. At the site of use, the intermediate composition is activated and transformed into polyamidoamine resin suitable for use, e.g. as wet strength agent in manufacture of fibrous cellulosic webs, such as paper, board or the like. The final crosslinking of the intermediate composition is initiated in an on-site process by increasing the pH of the intermediate composition to a pH value >7, for example to a pH of 8-9 and then increasing the temperature of the composition to an elevated temperature, for example 55-65° C. When desired viscosity increase is achieved, i.e. the desired crosslinking level, the crosslinking reaction is brought to end by addition of an acid.

### EXPERIMENTAL

Some embodiments of the invention are described in the following non-limiting examples.

### Analysis Methods

### Weight Average Molecular Weight

The weight average molecular weight (Mw) is determined by size-exclusion chromatography (SEC) using Agilent 1100 SE chromatography equipment with integrated pump, autosampler and degasser. Eluent is a buffer solution (0.3125 M CH3COOH+0.3125 M CH3COONa) with a flow rate of 0.5 ml/min at 35° C. Typical sample concentration is 2-4 mg/ml, with an injection volume of 50 μl. Ethylene glycol (1 mg/ml) is used as a flow marker. Column set consists of three columns (a TSKgel PWXL guard column and two TSKgel GMPWXL columns). Refractive index detector by Agilent is used for detection (T=35° C.). Molecular weight is determined using conventional (column) calibration with poly(ethylene oxide)/poly(ethylene glycol) narrow molecular weight distribution standards (Polymer Standards Service).

### Dry Solids Content

Dry solids content was determined by using Mettler Toledo HR73, at 150° C.

### Viscosity

Viscosity is determined by using Brookfield LV DV1, equipped with small sample adapter, at 25° C., using spindle S18. The highest feasible rotation speed for the spindle was used.

pH

pH was determined by using a calibrated pH-meter.

### Charge Density

Charge density was determined at pH 9.5, adjusted with 10 weight-% aqueous NaOH solution, by charge titration using polyethylene sulfonate solution as titrant. Mütek PCD-03 was used for end point detection.

### Non-Bound Chloride Content

Chloride content was determined by potentiometric titration with Methrom 916 Ti-Touch titrator with I—Ag (Ref. 60470300) electrode and silver nitrate (0.1 N) as titrant. Before analysis, sample was diluted to about 2% concentration with deionized water. 100 ml of diluted solution was acidified with 3 ml 70% nitric acid and mixed for 1 min before titration.

### Determination of Epihalohydrin and Halogen Containing By-Products

Epihalohydrin and halogen containing by-products, especially 1,3-dihalo-2-propanol (DCP) and 3-halopropyleneglycol (CPD), in the intermediate compositions were determined by gas chromatography.

### Adsorbable Organic Halogen (AOX) Content

Adsorbable organic halogen (AOX) content in the intermediate composition is determined by a standard method, ISO 9562:2004 (Water quality-Determination of adsorbable organically bound halogens (AOX)). Before determination, if needed, the sample of intermediate composition is diluted to a concentration, which provides an AOX content for the sample within the detection limits of the standard. The dilution is done with distilled water, and the AOX content is calculated by taking into account the dilution.

### Comparative Example 1

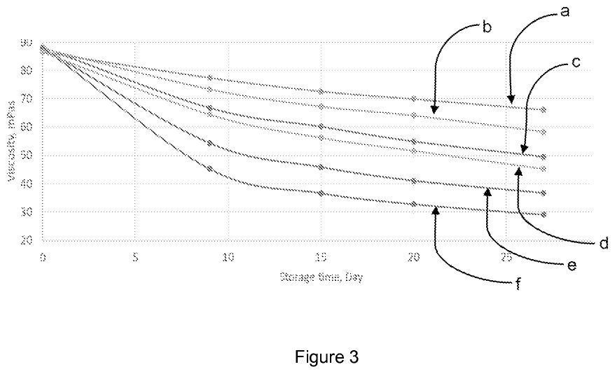

The impact of pH and temperature on stability of conventional commercial PAE resin, at conventional storage conditions, is exemplified in FIG. 3.

The viscosity change, as function of time, is shown for the following PAE resins:
a=start pH 3.0, temperature 23° C.
b=start pH 2.8, temperature 23° C.
c=start pH 2.6, temperature 23° C.
d=start pH 3.0, temperature 35° C.
e=start pH 2.8, temperature 35° C.
f=start pH 2.6, temperature 35° C.

It is seen from FIG. 3 that at acidic start pH of 3.0 or less, the viscosity of PAE resin decreases as function of time, especially at higher temperature, due to the resin hydrolysis. At start pH values over 3 (results not shown), the crosslinking of PAE resin will lead to gel formation and significant viscosity increase which leaves the resin unworkable.

### Example 1: Synthesis of Intermediate Compositions

Intermediate compositions comprising polyamidoamine derivative was synthesized by the following procedure.

Polyamidoamine, which was a condensation polymer of adipic acid and diethylenetriamine (molar ratio about 1), dry content 45 weight-%, viscosity 300 mPas, pH 9.8, molar amine proportion 4.5 mmol/g polymer, Mw 5 600 g/mol was used in the as a prepolymer. 580 g of polyamidoamine and 70 g of water was mixed in a glass reactor equipped with a heating and cooling device, a mechanical agitator with a propeller and a condenser. The polyamidoamine-water mixture was cooled to a temperature of 19° C. 123 g of epichlorohydrin was dosed under 5 min. Temperature was kept at 19-20° C. by cooling, and the reaction mixture was mixed at 20° C. for 20 h. The obtained polyamidoamine derivative was then acidified with 104 g of sulfuric acid (50%). The obtained polyamidoamine derivative was denoted as “product 1A”, it was analyzed and its characteristics are given in Table 1.

The above procedure for synthetization of polyamidoamine derivative was repeated, expect after 20 h reaction at 20° C., the mixture was heated to 50° C. in 1.7 h, after which the obtained polyamidoamine was acidified with 87 g of sulfuric acid (50%). The obtained polyamidoamine derivative was denoted as “product 1B”, it was analyzed and its characteristics are given in Table 1.

The procedure for synthetization of “product 1B” was repeated, expect after heating the reaction mixture to 50° C., the mixture was agitated at that temperature for 1.4 h, and then acidified with 59 g of sulfuric acid (50%). The obtained polyamidoamine derivative was denoted as “product 1C”, it was analyzed and its characteristics are given in Table 1.

TABLE 1
Intermediate compositions of Example 1.

| | Intermediate Composition | | |
|---|---|---|---|
| | Product 1A | Product 1B | Product 1C |
| Dry content, % | 50.4 | 50.9 | 51.2 |
| Polyamidoamine derivative content, weight-% | 44.5 | 45.9 | 47.6 |
| Content of azetidinium groups, mol-% | 15.0 | 31.0 | 52.0 |
| Viscosity, mPas | 215 | 291 | 952 |
| pH | 3.7 | 3.5 | 3.3 |
| Content of 1,3-DCP, mg/kg composition | 1 202 | 1 180 | 1 241 |
| Content of 3-CPD, mg/kg composition | 651 | 586 | 601 |
| Content of epichlorohydrin, mg/kg composition | 551 | 121 | 14 |
| Total AOX (Cl), g/kg composition | 46.1 | 38.1 | 27.1 |
| AOX in ECH, DCP, CPD, g/kg composition | 1.08 | 0.88 | 0.88 |
| Determined non bound Cl-ion, g/kg composition | 7.9 | 16.9 | 29.8 |
| Derivative bound AOX, g/kg composition | 45.0 | 37.3 | 26.2 |
| Derivative bound AOX, g/kg dry material | 89.4 | 73.2 | 51.2 |
| Ratio of derivative bound Cl/Cl-ion | 5.74 | 2.20 | 0.88 |
| Weight average molecular weight, g/mol | — | — | 26 000 |

Products 1A, 1B and 1C were stored at temperature of 22° C. and at 35° C. The results are shown in Table 2.

TABLE 2
Results of storage test for intermediate compositions at 22° C., at 35° C.

| | Product 1A | | | Product 1B | | | Product 1C | | |
|---|---|---|---|---|---|---|---|---|---|
| Storage | | | non-bound | | | non-bound | | | non-bound |
| time | Viscosity | | Cl-content | Viscosity | | Cl-content | Viscosity | | Cl-content |
| [d] | [mPas] | pH | [%] | [mPas] | pH | [%] | [mPas] | pH | [%] |

Storage at 22° C.

| | | | | | | | | | |
|---|---|---|---|---|---|---|---|---|---|
| 0 | 215 | 3.7 | 0.79 | 291 | 3.5 | 1.69 | 952 | 3.3 | 3.0 |
| 14 | 221 | 3.6 | — | 310 | 3.6 | — | 1526 | 3.7 | 3.0 |
| 30 | 222 | 3.3 | 1.06 | 329 | 3.4 | 1.79 | 3650 | 3.7 | — |
| 51 | 222 | 3.4 | — | 337 | 3.5 | — | 30000 | — | — |
| 92 | 218 | 3.1 | — | 350 | 3.3 | — | — | — | — |

Storage at 35° C.

| | | | | | | | | | |
|---|---|---|---|---|---|---|---|---|---|
| 0 | 215 | 3.7 | 0.79 | 291 | 3.5 | 1.7 | 952 | 3.29 | 3.0 |
| 14 | 207 | 3.0 | — | 329 | 3.3 | — | thick gel | NM | NM |
| 30 | 186 | 2.9 | 1.65 | 329 | 3.3 | 2.1 | — | — | — |
| 51 | 164 | 3.0 | — | 313 | 3.3 | — | — | — | — |
| 92 | 138 | 3.0 | — | 291 | 3.2 | — | — | — | — |

It can be seen from Table 2 that the intermediate composition “product 1B” with derivative bound halogen amount of 73 g/kg dry material, provided excellent pH and viscosity stability at temperatures 22° C. and 35° C., even at prolonged storage times. The viscosity of the intermediate composition “product 1A” with derivative bound halogen amount of 89 g/kg dry material, showed decrease during prolonged storage at 35° C., which indicated decrease in molecular weight. However, “product 1A” is still applicable for use for PAE wet strength resin production even though molecular size of the intermediate is reduced. It should be also noted that “product 1A” still showed good stability, even at elevated temperature, under one month storage, which is in most case fully appropriate. Viscosity of the intermediate composition “product 1C” with derivative bound halogen amount of 51 g/kg dry material increased during storage. It was anticipated that the storage stability can be improved by lowering the start pH.

### Example 2: Synthesis of Intermediate Composition at High Concentration

Polyamidoamine, which was a condensation polymer of adipic acid and diethylenetriamine (molar ratio about 1), dry content 46 weight-%, viscosity 520 mPas, pH 10.5, molar amine proportion 5.0 mmol/g polymer, Mw 5 900 g/mol was used in the as a prepolymer. 587 g of polyamidoamine and 32 g of water was mixed in a glass reactor equipped with a heating and cooling device, a mechanical agitator with a propeller and a condenser. The polyamidoamine-water mixture was cooled to a temperature of 19° C. 135 g of epichlorohydrin was dosed under 5 min. Temperature was kept at 19-20° C. by cooling, and the reaction mixture was mixed at 20° C. for 18 h. The reaction mixture was heated to 45° C. in 1.5 h. 682 g of the obtained polyamidoamine derivative was then acidified with 46 g of sulfuric acid (50%). The obtained polyamidoamine derivative was denoted as “product 2A”, it was analyzed and its characteristics are given in Table 3.

300 g of product 2A was diluted with 34 g of water, denoted as “product 2B”, and analyzed. Characteristics of “Product 2B” are given in Table 3.

TABLE 3
Intermediate compositions of Example 2, after acidification.

| | Intermediate Composition | |
|---|---|---|
| | Product 2A | Product 2B |
| Dry content, % | 57.9 | 52.0 |
| Polyamidoamine derivative | 51.8 | 46.8 |
| content, weight-% | | |
| Content of azetidinium groups, mol-% | 26.6 | 26.6 |
| Viscosity, mPas | 1118 | 394 |
| pH | 3.5 | 3.5 |
| Content of 1,3-DCP, mg/kg composition | 1813 | — |
| Content of 3-CPD, mg/kg composition | 370 | — |
| Content of epichlorohydrin, | 51 | — |
| mg/kg composition | | |
| Total AOX (Cl), g/kg composition | 47.5 | — |
| AOX in ECH, DCP, CPD, g/kg composition | 1.13 | — |
| Determined non bound Cl-ion, | 16.8 | — |
| g/kg composition | | |
| Derivative bound AOX, g/kg composition | 46.4 | |
| Derivative bound AOX, g/kg dry material | 80.1 | — |
| Ratio of derivative bound Cl/Cl-ion | 2.8 | — |

Products 2A and 2B were stored at temperature of 35° C. The results are shown in Table 4.

TABLE 4
Results of storage test for intermediate compositions at 35° C.

| Intermediate Composition | |
|---|---|
| Product 2A | Product 2B |
| Dry content, % | |
| 58 | 52 |

Storage at 35°

| Storage time | Viscosity | | Viscosity | |
|---|---|---|---|---|
| [d] | [mPas] | pH | [mPas | pH |
| 0 | 1118 | 3.5 | 394 | 3.5 |
| 17 | 1068 | 3.3 | 406 | 3.2 |
| 31 | 1050 | 3.2 | 383 | 3.1 |
| 57 | 907 | 3.4 | 334 | 3.1 |

It is seen from Table 4 that both “Product 2A” and “Product 2B” are stable at 35° C. The original viscosity of “Product 2A” was due to the high concentration of 58 weight-% of the polyamidoamine derivative in the intermediate composition, not due to premature crosslinking. It is seen that viscosity can be adjusted to lower level simply by dilution (Product 2B), without any detrimental effects to stability.

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. An intermediate composition in form of an aqueous solution for manufacture of a polyamidoamine epihalohydrin resin, wherein the intermediate composition has a dry solids content of 30-65 weight-%, and wherein the intermediate composition comprises
a regulating acid, and
30-60 weight-% of a polyamidoamine derivative having covalently bound epihalohydrin groups and covalently bound azetidinium groups, calculated from the total weight of the intermediate composition,
wherein the intermediate composition comprises derivative bound halogen in an amount of ≤90 g/kg, preferably 20-90 g/kg, calculated from the dry solids.

2. The intermediate composition according to claim 1, wherein the intermediate composition comprises derivative bound halogen in the amount of 30-90 g/kg, preferably 35-85 g/kg, more preferably 40-80 g/kg, calculated from the dry solids.

3. The intermediate composition according to claim 1, wherein the intermediate composition has a pH value in a range of 2.8-4, preferably 3.0-3.8, more preferably 3.1-3.8, even more preferably 3.2-3.7.

4. The intermediate composition according to claim 1, wherein the intermediate composition has the dry solids content in the range of 40-65 weight-%, preferably 45-65 weight-%, more preferably 50-60 weight-%, even more preferably 50-58 weight-%.

5. The intermediate composition according to claim 1, wherein the intermediate composition comprises 35-60 weight-%, preferably 43-57 weight-%, more preferably 45-55 weight-%, given as dry, of the polyamidoamine derivative.

6. The intermediate composition according to claim 1, wherein the regulating acid is an inorganic acid.

7. The intermediate composition according to claim 6, wherein the inorganic acid is selected from hydrochloric acid, sulphuric acid, nitric acid, phosphoric acid, or any of their combinations.

8. The intermediate composition according to claim 1, wherein the intermediate composition comprises non-bound halogen ions, wherein a ratio of derivative bound halogen ions to non-bound halogen ions is ≤5.

9. The intermediate composition according to claim 8, wherein the ratio is 0.5-5, preferably 1-4.5, more preferably 1.5-4.0.

10. The intermediate composition according to claim 1, wherein the intermediate composition has a viscosity value in a range of 50-2000 mPas, preferably 50-1000 mPas, more preferably 100-700 mPas.

11. The intermediate composition according to claim 1, wherein the intermediate composition is obtained by reacting a polyamidoamine and epichlorohydrin.

12. The intermediate composition according to claim 1, wherein the polyamidoamine derivative comprises 30-80 mol-%, preferably 50-80 mol-%, more preferably 60-80 mol-%, even more preferably 60-77 mol-%, of pendant halohydrin groups.

13. The intermediate composition according to claim 1, wherein the polyamidoamine derivative comprises 20-40 mol-%, preferably 21-40 mol-%, more preferably 25-35 mol-%, of pendant azetidinium groups.

14. The intermediate composition according to claim 1, wherein the polyamidoamine derivative has a weight average molecular weight of ≤150 000 g/mol, preferably ≤100 000 g/mol, more preferably ≤50 000 g/mol, even more preferably <35 000 g/mol.
